(19) United States
(12) Patent Application Publication
(10) Pub. No.: US 2005/0275661 A1
(43) Pub. Date: Dec. 15, 2005

(54) Displaying a trusted user interface using background images

(76) Inventors: Joseph F. Cihula, Hillsboro, OR (US); Ernie Brickell, Portland, OR (US); Chiung-Chen Yu, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/866,004

(22) Filed: Jun. 10, 2004

(51) Int. Cl. G09G 5/00

(52) U.S. Cl. 345/619; 726/26

(57) ABSTRACT

In one implementation, a method for ensuring the trustworthiness of graphical user interfaces is described wherein a computing system user selects and/or modifies an image to be used as at least a portion of the background of one or more visual elements of a graphical user interface of a trusted computing environment. The user selected background image facilitates recognition by the user of the trustworthiness of the environment's graphical user interface when it is displayed to the user. The computing system seals the selected image or a modified version of the selected image within the trusted computing environment to prevent access to that image by computing environments other than the trusted computing environment. Additional embodiments are described and claimed.

### BACKGROUND

Modern computing systems often provide users with the ability to simultaneously support multiple execution environments typically using some form of virtualization scheme to delineate the execution environments within the system. Each environment can support its own operating system and software processes and, depending on the virtualization scheme, a particular environment and its software processes can be isolated to varying degrees from other environments. In the context of multiple environments users often need to “trust” to a high degree of certainty the ability of one or more particular environments to protect data within those environments from being accessed or altered by other environments.

Creating a trusted environment completely protected from other environments is problematic and users are often presented with the challenge of fending off attacks on trusted environments originating from malicious software executing within other environments. While such attacks can take many forms some of the most insidious do not involve direct attacks on a trusted environment but instead rely on mimicry to convince the user that they are interacting with a trusted environment. Because typical computing systems represent multiple environments by using a separate user interface (UI), usually one or more distinct graphical windows, for each environment, malicious entities that can mimic a trusted environment's UI or window can readily deceive a user into believing he or she is interacting with the trusted environment. Providing users with a truly robust trusted computing environment requires that users can readily recognize and distinguish the trusted environment's UI from the UIs of other environments present on the system.

### BRIEF DESCRIPTION OF THE DRAWINGS

The accompanying drawings, which are incorporated in and constitute a part of this specification, illustrate one or more implementations consistent with the principles of the invention and, together with the description, explain such implementations. The drawings are not necessarily to scale, the emphasis instead being placed upon illustrating the principles of the invention. In the drawings:

FIG. 1 illustrates an example system;

FIG. 2 illustrates an example image for use in the system of FIG. 1;

FIG. 3 illustrates the display output of the system of FIG. 1 incorporating the image of FIG. 2;

FIG. 4 is a flow diagram illustrating a process for implementing a trusted user interface using background image; and

FIG. 5 is a flow diagram illustrating another process for implementing a trusted user interface using background image.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of the claimed invention. However, it will be apparent to those skilled in the art, having the benefit of the present disclosure, that the various aspects of the invention claimed may be practiced in other examples that depart from these specific details. In certain instances, descriptions of well known devices, circuits, and methods are omitted so as not to obscure the description of the present invention with unnecessary detail.

### Trusted User Interface System

Computer software within a computing system runs in an execution environment provided by the computing system's software and hardware. A trusted execution environment ( or, simply, a “trusted environment”) is one that isolates and protects software running (or “executing”) within the trusted environment from all other software executing within other execution environments regardless of the privilege level(s) of the other software. A computing system's execution environments provide software process execution with a range of system privileges: for example, some software processes may have privileges providing those processes with access to system-wide control registers or with access to another process' data while other processes are not permitted such system-wide access privileges. Each execution environment has a defined level of privilege with respect to the system and processes executing within a particular environment cannot exceed that environment's privileges.

A trusted environment is one that isolates and protects any software process executing within it and that supports sealing of data to processes within it. A trusted environment has the ability to seal and/or isolate data within the trusted environment such that the data can only be read or used within the trusted environment to which the data was sealed. For example, while the invention is not limited in this respect, one method for sealing a trusted environment's data is to encrypt the data using a secure encryption algorithm and to use a message authentication code to detect modifications. A trusted environment's sealed data can be stored in system memory or otherwise persisted within the system without exposing that data to observation or undetectable alteration by other system environments. Sealed data cannot be accessed or altered by any other execution environment (trusted or otherwise) without detection by the trusted environment.

A trusted environment supports trusted input and trusted output. Trusted input is user input (e.g. input from a keyboard or other user-operated I/O device) that is guaranteed to only be accessible from a trusted environment. Trusted output is system output (e.g. graphics output to a display) that is likewise guaranteed to only be accessible or generable from a trusted environment. A trusted user interface (or trusted UI) is a graphical user interface that supports one or more trusted environments using trusted input and trusted output. A trusted UI includes UI elements (or simply, “elements”) as the visual components of the trusted graphical user interface. A trusted UI's elements include, but are not limited to, windows, icons, links and the like. Further, UI elements may contain content areas and non-content areas.

Content areas of a UI element contain content or data of interest to the user and may include, but are not limited to, areas where information such as the software process' application name, output text and fields for user input are displayed. For example, content areas include, but are not limited to, the window's title bar and content pane. Non-content areas of a UI element include, but are not limited to; sizing borders, min/max restore widgets etc. UI elements are considered to be higher level than the bitmap images they are derived from in that they exist as defined components in a trusted UI's graphical display system rather than simply as a collection of data bits in the system's display buffer. In the display context, the elements of a trusted UI need to provide the user with the ability to distinguish which trusted environment a given element belongs to when the user observes that element. In the input context, a trusted UI needs to assure that input data associated with a given UI element is only available to the trusted environment associated with that element.

A UI has system focus when it is the UI within the system actually receiving user input. Only one UI can have system focus at any one time although in a system composed of multiple subsystems each subsystem may provide one of its own UIs with subsystem focus at any given time. When a trusted UI has a UI element with focus then only software running in that particular trusted UI and associated with that UI element can read the user input provided to the UI element.

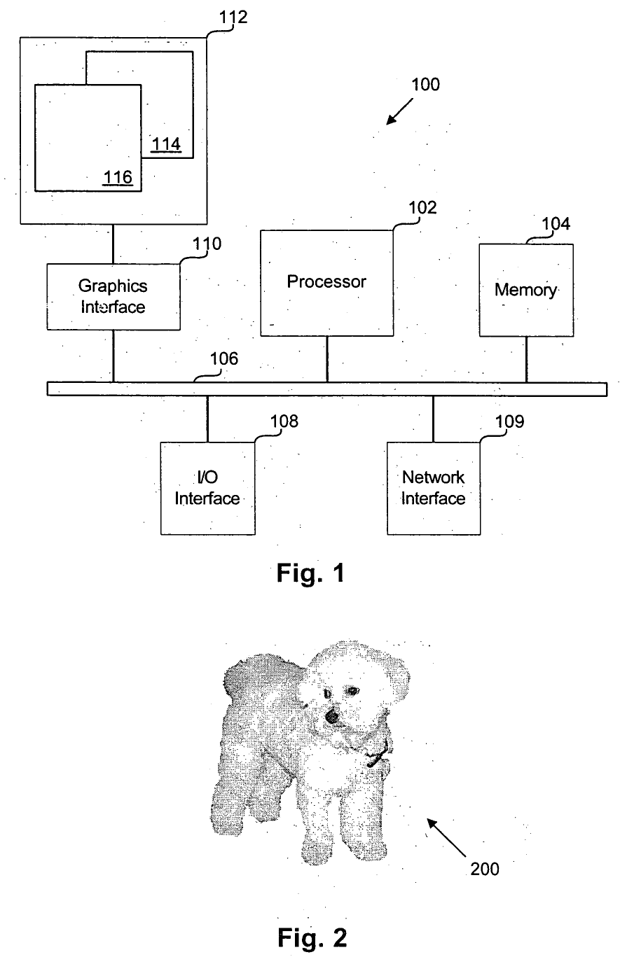

FIG. 1 illustrates an example system 100. Example implementations of system 100 may include a mobile computer, a portable digital device such as a personal digital assistant (PDA), a consumer electronics device, a general-purpose computer or another electrical system although the claimed invention is not limited in this regard. Although system 100 may be embodied in a single device, in some implementations certain components of system 100 may be remote and/or physically separated from other components of system 100. Further, although system 100 is illustrated as including discrete components, these components may be implemented in hardware, software/firmware, or some combination thereof. When implemented in hardware, some components of system 100 may be combined in a certain chip or device.

System 100 may include a processor 102, memory 104, a bus 106, an I/O interface 108, a network interface 109, a display controller or graphics interface 110, a display 112, and multiple graphical user interfaces (UIs) 114 and 116. Processor 102 may be coupled to bus 106 for communicating with other system devices such as memory 104 and graphics interface 110. Bus 106 may be a peripheral component interconnect (PCI) bus although the invention is not limited in this respect. I/O interface may permit processor 102 or graphics interface 110 to communicate with I/O devices (not shown) such as a Bluetooth® wireless universal asynchronous receiver/transmitter (UART) or a universal serial bus (USB) linked to USB-compliant external devices although the invention is not limited in this regard.

While memory 104 and graphics interface 110 may be physically separated from processor 102 the invention is not limited in this respect and encompasses, for example, embodiments wherein memory and/or the graphics interface are embedded within processor 102. Moreover, all or portions of the components of system 100 may be incorporated within a single integrated circuit (IC) “system on a chip” or incorporated into a collection of IC's interconnected to form a “package” without departing from the scope or spirit of the claimed invention.

Both I/O interface 108 and network interface 109 may comprise any suitable interface controllers to provide for any suitable communication link to different components of the system 100. For example, I/O interface 108 may communicatively couple system 100 to one or more suitable integrated drive electronics (IDE) drives, such as a hard disk drive (HDD) or compact disc read only memory (CD ROM) drive to store still or video image data and/or software instructions. I/O interface 108 may also communicatively couple system 100 to one or more suitable universal serial bus (USB) devices through one or more USB ports, an audio coder/decoder (codec), and a modem codec, to name just a few examples. I/O interface 108 may, in one implementation, also provide an interface to a keyboard, a mouse, and one or more suitable devices, such as a printer for example, through one or more ports. Network interface 109 may provide an interface to one or more networks external to system 100, including, for example, a local area network (LAN) permitting system 100 to be communicatively coupled, for example, to external sources providing streaming video data.

As will be further described below, software instructions stored in memory 104 and executed by processor 102 may configure system 100 to provide at display 112 visual UI elements (e.g., windows) associated with specific environments running on system 100, in particular, trusted output in the form of trusted UI 116 associated with a trusted environment executing on system 100. In one implementation, software instructions executing within processor 102 may alter the appearance of the trusted environment's trusted UI 116 to differentiate trusted UI 116 from other UIs, trusted or not, such as UI 114 presented on display 112. When trusted UI 116 contains transparent portions and is positioned on display 112 such that it is in front of and overlaps with UI 114, system 100 may present trusted UI 116 such that UI 114 cannot be seen through the transparent portions of the trusted UI 116. In addition, system 100 may display one or more visual UI elements of the trusted environment having focus, such as UI 116 in front of or on top of the visual UI elements of other environments, such as UI 114. To better illustrate the invention, a more detailed description of an implementation of trusted UI 116 will now be provided.

### Trusted User Interface

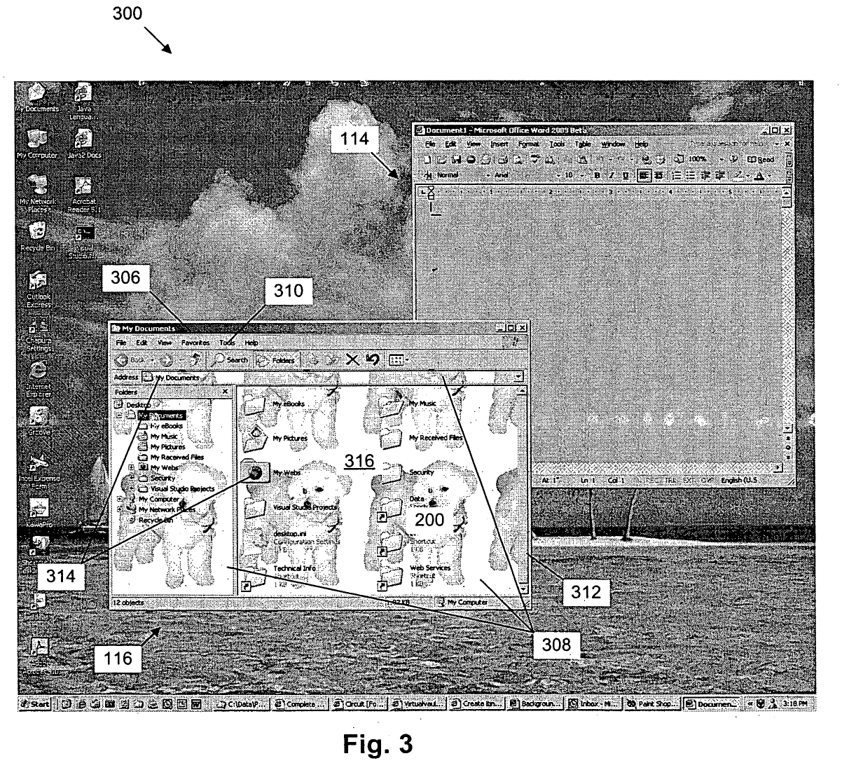

FIG. 2 illustrates an example image 200 for use in system 100. FIG. 3 illustrates in more detail an implementation of display output 300 of system 100 incorporating the image of FIG. 2. While several terms related to trusted computing environments have been defined above and are used below in order to facilitate description of this embodiment of a trusted UI it should be understood that the invention is not limited by the specific terms as defined and that other definitions and usages of terms and descriptions may be used consistent with the scope and spirit of the invention as disclosed herein.

While the implementation shown in FIGS. 1 and 3 incorporates a single display 112 displaying UI elements from multiple trusted environments, the invention is not limited in this respect and also encompasses the use of trusted UIs in the context of other UI methods such as screen splitting, multiple display screens used by one computing system etc. In addition, while the embodiment described herein contemplates multiple trusted environments where the number of trusted environments may be large and each environment may have different responsibilities and properties, the invention is not limited in this respect and also encompasses, for example, a system that only supports two environments one of which is more trusted than the other or a system in which only one environment is trusted.

A user of system 100 may choose image 200 for use in presenting trusted UI 116 so that the user may recognize that UI 116 originates from a trusted environment when the user observes UI 116. Display output 300 of display 112 may include trusted UI 116, UI 114, as well as a “desktop” menu bar and assorted icons as may typically appear in display output 300 when system 100 uses a windows-based operating system such as Microsoft® Windows XP®. While the UI visual elements shown in FIG. 3 are meant to be representative of those UI visual elements found in a windows-based operating system, the invention is not limited in this respect and contemplates all UI visual elements of all operating systems that are consistent with the invention as described herein. Trusted UI 116 may include various UI visual elements such as a title bar 306, content panes 308, a menu bar 310, and scroll bar 312. Trusted UI 116 may also include data or content 314 within both title bar 306 and content panes 308. The content 314 within title bar 306 may include, for example, the application name and or title of the software process associated with trusted UI 116. Content 314 within content panes 308 may include, for example, file folder icons, hierarchical files and the like although the invention is not limited in this regard. Trusted UI 116 may include a background 316 appearing visually behind the content 314 within content panes 308.

In the implementation of FIG. 3, trusted UI 116 may only be trustworthy when it has focus (i.e. when trusted UI 116 is the top-most UI in output 300). Because trusted UI 116 of the implementation of FIGS. 1 and 3 may only be trustworthy when UI 116 has focus, a user of system 100 may rely upon the appearance of image 200 behind content 314 to ascertain that trusted UI 116 is truly trustworthy. When UI 116 does not have focus, system 100 may or may not remove image 200 from the background 316 of UI 116. By using image 200 as the background 316 of content panes 308, the implementation of FIG. 3 may limit the visual clutter that a user might otherwise perceive had image 200 been used as the background of other visual elements of trusted UI 116 such as title bar 306. While in the implementation of FIG. 3, image 200 is tiled across the entire area of content panes 308 so that multiple copies of image 200 form the background 316 of content panes 308, the invention is not limited in this respect and other methods such as cropping (where only a portion of image 200 is used to form background 316) or stretching (where a single copy of image 200 is altered such that it forms all of background 316), to name a few examples, may be used and remain within the scope of the invention. Alternatively, a single copy of image 200 or multiple copies of image 200 may form only a portion of background 316 and remain within the scope of the invention.

Additional implementations may allow trusted UI 116 of system 100 to retain its trustworthiness even when UI 116 is not the UI having system focus (i.e. is not receiving user input and thus is not top-most). For example, although the invention is not limited in this regard, circumstances may arise where UI 114 has system focus (i.e. is receiving user input) and may partially obscure the visual elements of trusted UI 116 including content panes 308. To ensure that a user of system 100 may ascertain the trustworthiness of UI 116 even though UI 116 does not have system focus, an additional implementation may extend the application of image 200 in UI 116 to include the use of image 200, or portions or multiple copies of image 200, as a background image behind other content-bearing visual elements such as, but not limited to, title bar 306. Moreover, other implementations may extend the use of image 200, or portions or multiple copies of image 200 to other, non-content bearing visual elements of UI 116, such as scroll bar 312.

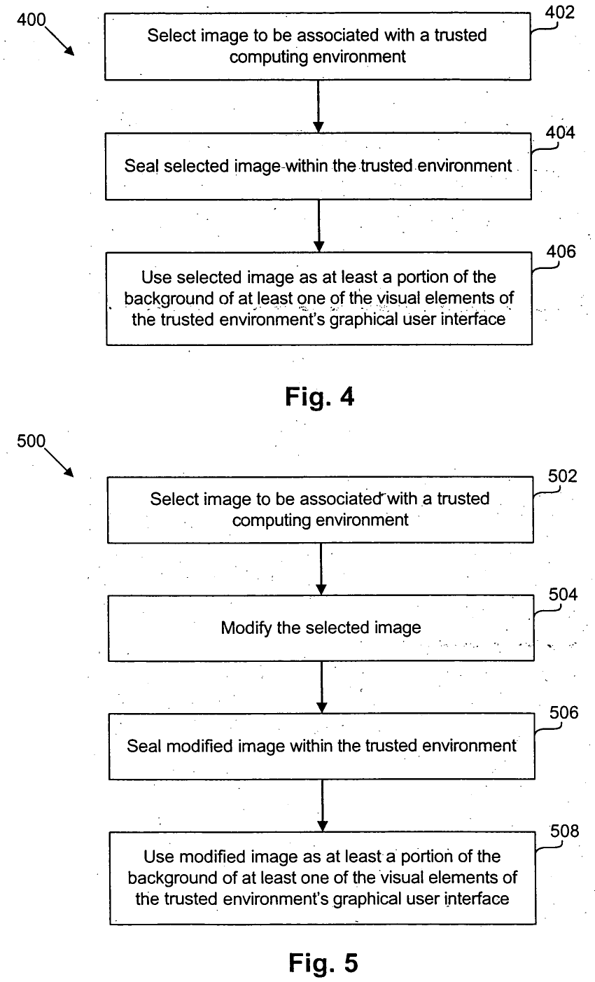

FIG. 4 is a flow diagram illustrating a process 400 for implementing a trusted user interface using a background image. Although process 400 may be described with regard to system 100 for ease of explanation, the claimed invention is not limited in this regard. The image to be used may be selected by a user from a variety of sources including, but not limited to, images found on the internet, a digital or scanned photograph (which is likely to provide the most uniqueness with regard to user recognition of the image) or selected from a set of pre-defined images. Alternatively, the selected image may be a unique image created by the user with the aid of application software such as Adobe® Photoshop®, for example. A user may select a different image for each trusted environment or may select the same image for one or more trusted environments. Alternatively, the user may choose not to associate any image with one or more environments.

Processing may begin with the selection, by a user of system 100, of an image to be associated with a trusted computing environment [act 402]. The image (e.g., image 200) may be selected by a user based on that image's uniqueness and recognizability to the user in order to provide user recognition of the trustworthiness of trusted UI 116. To preserve trustability, the image chosen or selected in act 402 may be selected by the user using system 100 when system 100 is in a trusted state or when the image is selected from within a trusted computing environment. System 100 may be in a trusted state by being in an initial trusted state or by being placed in a state whose trust may be verified. System 100 may be in an implicitly trusted state when first used (e.g. just unboxed). The image may also be selected when the system 100 is in a state that the user believes is not under attack.

Processing may continue with the selected image being sealed by system 100 within the trusted environment associated with the trusted UI 116 [act 404]. System 100 may then apply the selected and sealed image to form at least a portion of the background of at least one of the visual elements, such as at least a portion of the background 316 of content panes 308, of trusted UI 116 [act 406].

FIG. 5 is a flow diagram illustrating a process 500 for implementing a trusted user interface using a background image. Although process 500 may be described with regard to system 100 for ease of explanation, the claimed invention is not limited in this regard. Processing may begin with the selection, by a user of system 100, of an image to be associated with a trusted computing environment [act 502]. To preserve trustability, the image chosen or selected in act 502 may be selected by the user using system 100 when system 100 is in a trusted state or when the image is selected from within a trusted computing environment. System 100 may be in a trusted state by being in an initial trusted state or an implicitly trusted state or by being placed in a state whose trust may be verified.

Processing may continue with the user modifying the selected image [act 504]. The image modification undertaken in act 504 may include, but is not limited to, cropping, stretching, sharpening or otherwise modifying the image characteristics of the image selected in act 502. Alternatively, system 100 may alter the image selected in act 502 or system 100 may alter the selected image in addition to any alteration the user may have performed on the image. System 100 may alter the color saturation or brightness of the image so that the visual element is easier to read over the background selected image. In act 506 the modified image may be sealed within the trusted environment associated with trusted UI 116. System 100 may then apply the selected and sealed image to form at least a portion of the background of at least one of the visual elements, such as at least a portion of the background 316 of content panes 308, of trusted UI 116 [act 508].

Additional implementations may include modifying the visual element to make the background selected image easier to detect. System 100 may alter the transparency of the visual element, so that the background selected image could be detected in the background behind the visual element. In addition, system 100 could make the modifications to the visual element and the background selected image dependent upon each other. For example, the background visual element may have higher color saturation in portions of the visual element that are mostly white space. The color choices of the visual element and the background selected image may be modified so that they do not interfere with readability and detection.

Additional implementations may include modifying the selected image after the selected image is sealed within the trusted computing environment. Such post-sealing modification may be undertaken by the user, the system, or both the user and the system. In such an implementation the modified image may be re-sealed within the environment and replace the original image. The user may choose to make this change on a periodic basis, say every 6 months, or to change the image if the user suspects that someone he doesn't trust has seen the image or had an opportunity to photograph the image. Moreover, in general, the system may modify the selected image, with or without user participation, before or after sealing to, for example, make the selected image more visually appealing although the invention is not limited in this regard. If the system modifies the selected image it may inform the user of the modification so that the user can recognize the modified image.

The acts shown in FIGS. 4 and 5 need not be implemented in the order shown; nor do all of the acts necessarily need to be performed. For example, in process 500 the act of modifying the selected image may be performed after the act of sealing the image—although in such circumstances the modified may be re-sealed in an additional act not shown in process 500. Also, those acts that are not dependent on other acts may be performed in parallel with the other acts. Further, at least some of the acts in this figure may be implemented as instructions, or groups of instructions, implemented in a machine-readable medium.

The foregoing description of one or more implementations consistent with the principles of the invention provides illustration and description, but is not intended to be exhaustive or to limit the scope of the invention to the precise form disclosed. Modifications and variations are possible in light of the above teachings or may be acquired from practice of various implementations of the invention.

For example, the system, apparatus and methods for displaying a trusted user interface using background images described herein are not limited to systems or apparatus where the graphics interface communicates image data to the display over buses or cables. Rather, the claimed invention also contemplates a graphics interface that communicates with a display using wireless technologies while maintaining system security or trust. Also, although described in terms of a discrete graphics interface, in some implementations the graphics interface may be imbedded within a larger general purpose processor or system. For example, the graphics interface may be embedded along with a processor, buses, I/O interface, etc., within a single integrated circuit chip or a “system on a chip.” Clearly, many other implementations may be employed to provide for displaying a trusted user interface using background images consistent with the claimed invention.

No element, act, or instruction used in the description of the present application should be construed as critical or essential to the invention unless explicitly described as such. Also, as used herein, the article “a” is intended to include one or more items. Where only one item is intended, the term “one” or similar language is used. Variations and modifications may be made to the above-described implementation(s) of the claimed invention without departing substantially from the spirit and principles of the invention. All such modifications and variations are intended to be included herein within the scope of this disclosure and protected by the following claims.

1. A method comprising:
selecting an image to mark a trusted computing environment; and
sealing the image to the trusted computing environment.

2. The method of claim 1, wherein the trusted computing environment includes a graphical user interface having at least one visual element, the method further comprising:
using the selected image as at least a portion of the background of the visual element.

3. The method of claim 2, further comprising:
modifying the visual element to make the foreground of the visual element easier to read over the selected image.

4. The method of claim 2, further comprising:
modifying the selected image.

5. The method of claim 4, wherein modifying the selected image comprises adjusting the color saturation.

6. The method of claim 4, wherein modifying the selected image comprises adjusting the brightness.

7. The method of claim 2, further comprising:
modifying the visual element to make the selected image easier to detect.

8. The method of claim 7, wherein modifying the visual element comprises adjusting the transparency of the visual element.

9. The method of claim 2, further comprising:
modifying the visual element and the selected image dependent upon each other to enhance the visual element observation and the selected image detection.

10. The method of claim 2, wherein using the selected image comprises tiling the image to form the background.

11. The method of claim 2, wherein using the selected image comprises stretching the image to form the background.

12. The method of claim 2, wherein using the selected image comprises cropping the image to form the background.

13. A machine-accessible medium including instructions that, when executed, cause a machine to:
isolate a selected image within a trusted computing environment, the trusted computing environment including a graphical user interface having at least one visual element; and
apply the selected image as at least a portion of the background of the visual element.

14. The machine readable medium of claim 14, further including instructions that, when executed, cause a machine to:
modify the at least one visual element to make the foreground of the at least one visual element easier to read over the selected image.

15. The machine readable medium of claim 13, further including instructions that, when executed, cause a machine to:
modify the selected image.

16. The machine readable medium of claim 15, wherein modifying the selected image comprises adjusting the color saturation.

17. The machine readable medium of claim 15, wherein modifying the selected image comprises adjusting the brightness.

18. The machine readable medium of claim 13, further including instructions that, when executed, cause a machine to:
modify the at least one visual element to make the selected image easier to detect.

19. The machine readable medium of claim 18, wherein modifying the at least one visual element comprises adjusting the transparency of the at least one visual element.

20. The machine readable medium of claim 13, further including instructions that, when executed, cause a machine to:
modify the at least one visual element and the selected image dependent upon each other to enhance observation of the at least one visual element and detection of the selected image.

21. The machine readable medium of claim 13, wherein applying the selected image comprises tiling the image to form the background.

22. The machine readable medium of claim 13, wherein applying the selected image comprises stretching the image to form the background.

23. The machine readable medium of claim 13, wherein applying the selected image comprises cropping the image to form the background.

24. An apparatus comprising:
a machine-accessible medium including instructions that, when executed, cause a processor to perform operations comprising:
sealing an image to a trusted computing environment, the trusted computing environment including a user interface having at least one visual element; and
using the image as at least a portion of the background of the at least one visual element.

25. The apparatus of claim 24, wherein the instructions provided by the machine-readable medium further include instructions that, when executed, cause a processor to perform operations comprising:
modifying the image.

26. The apparatus of claim 24, wherein using the image comprises tiling the image to form the background.

27. The apparatus of claim 24, wherein using the image comprises stretching the image to form the background.

28. The apparatus of claim 24, wherein using the image comprises cropping the image to form the background.

29. A system comprising:
a processor to execute instructions; and
a memory coupled to the processor, the memory to store the instructions to be executed by the processor;
wherein, in response to the instructions, the processor performs operations comprising:
sealing an image selected to mark a trusted computing environment to the trusted computing environment, the trusted computing environment including a user interface having at least one visual element; and
using the image as at least a portion of the background of the at least one visual element.

30. The system of claim 29, wherein the processor performs operations further comprising:
modifying the selected image.
